(19) United States
(12) Patent Application Publication
(10) Pub. No.: US 2006/0130703 A1
(43) Pub. Date: Jun. 22, 2006

(54) Method for stabilising dispersions

(76) Inventors: Herbert Barthel, Emmerting (DE); Stephan Loskor, Kastl (DE); Mario Heinemann, Burghausen (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/545,831

(22) PCT Filed: Feb. 12, 2004
(86) PCT No.: PCT/EP04/01327

§ 371 Date: Aug. 17, 2005

(30) Foreign Application Priority Data
Feb. 20, 2003 (DE) 103 07 249.7
Mar. 17, 2003 (DE) 103 11 722.9
Jun. 5, 2003 (DE) 103 25 609.1

(51) Int. Cl. C08L 95/00

(52) U.S. Cl. 106/234

(57) ABSTRACT

Small amounts of boron or boron compounds are effective in stabilizing dispersions of metal oxides such as silica. Boron may be incorporated into fumed silica during its preparation in a flame, may be coated onto a metal oxide surface, or may be incorporated into the liquid continuous phase.

The invention relates to a method for stabilizing dispersions, a dispersion, and a process for the preparation of such a dispersion, a silica and a process for the preparation of such a silica.

The Cabot document EP 1 124 693 A1 discloses the stabilization of aqueous silica dispersions with aluminum salts for use for the coating of print media (paper).

This has the disadvantage that undesired color changes of the printing inks occur in the presence and under the influence of aluminum.

Other known methods for stabilizing SILICA dispersions comprise adding alkali and establishing a high pH with KOH or NaOH.

This has the disadvantage that damage to the paper occurs.

It is an object of the invention to overcome the disadvantages of the prior art.

Surprisingly, it has now been found that silica dispersions having very high solids contents in combination with excellent stability to gelling and sedimentation even after a long storage time can be prepared by using boron compounds for dispersions, in particular for silica dispersions, and with the use of a boron-containing silica.

The invention relates to a method for stabilizing dispersions, characterized in that the dispersion contains boron.

The dispersions can preferably be dispersions of metal oxides, such as silicas, such as aluminas, such as titanium dioxides, such as zirconium(IV) oxides, such as cerium(IV) oxides and such as zinc oxides.

In the method for stabilizing dispersions, boron is preferably used in an amount of from 0.00001% by weight to 8% by weight of boron, preferably from 0.0001% by weight to 8% by weight of boron, preferably from 0.001-5% by weight of boron and particularly preferably from 0.1-5% by weight of boron, boron always being calculated as pure boron in the boron-containing dispersion, based on the total boron-containing dispersion.

In the method for stabilizing dispersions, boron is preferably used in an amount of from 0.0001% by weight to 12% by weight of boron, preferably from 0.001-10% by weight of boron, particularly preferably 0.1-5% by weight of boron, boron always being calculated as pure boron in the boron-containing silica, based on the total boron-containing silica.

Dispersions containing metal oxides and boron form a further subject 5.

The dispersion according to the invention preferably contains the abovementioned metal oxides.

In the preparation of the dispersions according to the invention which contain boron, boron in the form of boron compound is mixed into a liquid.

In the preparation of the dispersions according to the invention which contain boron-containing silica, the boron-containing silica is mixed into a liquid.

Liquids are preferably those which have a low viscosity, preferably those having viscosities of less than 100 mPa·s at 25° C., such as, preferably, water, and other polar protic liquid media, such as alcohols, such as methanol, ethanol or isopropanol, di- and polyols, such as ethylene glycol, propylene glycol or glycerol, polar aprotic liquid media, such as ethers, such as tetrahydrofuran, ketones, such as acetone or isobutyl ketone, esters, such as ethyl acetate, amides, such as dimethylformamide, or sulfoxides, such as dimethyl sulfoxide, and nonpolar liquid media, such as alkanes, such as cyclohexanes, or aromatics, such as toluene. Water is particularly preferred.

For the preparation of the dispersions according to the invention, the boron compound can be added to the liquid and is distributed by wetting, or by shaking, as with a tumbler mixer, or a high speed mixer, or by stirring. At low silica concentrations of less than 10% by weight, simple stirring is generally sufficient for incorporating the silica into the liquid. Incorporation and dispersing of the silica in the liquid at a very high shear gradient are preferred. High-speed stirrers, high-speed dissolvers, for example having rotational speeds of 1-50 m/s, high-speed rotor-stator systems, sonolators, shear gaps, nozzles and ball mills are preferably suitable for this purpose.

This can be effected by a batchwise or by a continuous method.

Particularly suitable systems are those which first achieve the wetting and incorporation of silica in the liquid by means of effective stirring elements, for example in a closed container or vessel, and, in a second step, disperse the silica at a very high shear gradient. This can be effected by means of a dispersing system in the first container, or by pumped circulation in an external pipeline which contains a dispersing system, the dispersion being transported from the container, with preferably closed recycling, through the dispersing system into the container. By partial recycling and partial continuous removal, the process can preferably be designed to be continuous.

The use of ultrasound in the range from 5 Hz to 500 kHz, preferably from 10 kHz to 100 kHz, very particularly preferably from 15 kHz to 50 kHz, is particularly suitable for dispersing the silica in the dispersion according to the invention; the ultrasonic dispersion can be effected continuously or batchwise. This can be effected by means of individual ultrasonic generators, such as ultrasonic peaks, or in flow-through systems which, as systems optionally separated by a pipeline or pipe wall, may contain one or more ultrasonic generators.

Ultrasonic dispersing can be effected continuously or batchwise.

For the preparation of the dispersions according to the invention, the boron-containing silica can be added to the liquid and is distributed by wetting, or by shaking, for example by means of a tumbler mixer, or by means of a high speed mixer, or by stirring. In the case of low silica concentrations of less than 10% by weight, simple stirring is generally sufficient. Incorporation and dispersion of the boron-containing silica at a very high shear gradient is preferred. High-speed stirrers, high-speed dissolvers, for example having rotational speeds of 1-50 m/s, high-speed rotor-stator systems, sonolators, shear gaps, nozzles or ball mills are preferably suitable for this purpose.

This can be effected by a batchwise or by a continuous method.

Particularly suitable systems are those which first achieve wetting and incorporation of the silica in the liquid by means of effective stirring elements, for example in a closed container or vessel, and, in a second step, disperse the silica at a very high shear gradient. This can be effected by means of a dispersing system in the first container, or by pumped circulation in an external pipeline which contains a dispersing system, the dispersion being transported from the container, with preferably closed recycling, through the dispersing system back into the container. By partial recycling and partial continuous removal, this process can preferably be designed to be continuous. The use of ultrasound in the range from 5 Hz to 500 kHz, preferably from 10 kHz to 100 kHz, very particularly preferably from 15 kHz to 50 kHz, is particularly suitable for dispersing the silica in the dispersion according to the invention; the ultrasonic dispersing can be effected continuously or batchwise. This can be effected by individual ultrasonic generators, such as ultrasonic peaks, or in flow-through systems which, as systems optionally separated by pipeline or pipe wall, may contain one or more ultrasonic generators.

Ultrasonic dispersions can be effected continuously or batchwise.

In the case of the dispersion according to the invention which contains metal oxide, boron is preferably contained in an amount of from 0.00001% by weight to 8% by weight of boron, preferably from 0.0001% by weight to 8% by weight of boron, preferably from 0.001 to 5% by weight, particularly preferably 0.1-5% by weight, particularly preferably 0.5-5% by weight of boron, boron always being calculated as pure boron in the boron-containing dispersion, based on the total boron-containing dispersion.

In the dispersion according to the invention, boron is contained in the boron-containing silica preferably in an amount of from 0.0001% by weight to 12% by weight of boron, preferably from 0.001 to 10% by weight, particularly preferably 0.1-5% by weight, particularly preferably 0.5-5% by weight of boron, boron always being calculated as pure boron in the boron-containing silica, based on the total boron-containing silica.

Examples of preferred aqueous dispersions according to the invention are preferably those which contain 0.01-5% by weight of boron as a boron compound and which contains 70% by weight of a pyrogenic SILICA with BET=25-100 m²/g, or which contains 50% by weight of a pyrogenic SILICA with BET=100-200 m²/g, or which contains 1-40% by weight of pyrogenic SILICA with BET=200-450 m²/g, optionally other silicas and optionally other finely divided and colloidal solids, and contain water and optionally other additives, such as, for example, mineral acids, such as phosphoric acid, or organic acids, such as malic acid or propionic acid, or inorganic bases, such as potassium hydroxide or sodium hydroxide or ammonia, or organic bases, such as triethanolamine, or polymers, such as polyethylene glycol, or polypropylene glycol, or surfactants, such as anionic surfactants, such as dodecanesulfonic acid, or cationic surfactants, such as cetylpyridinium chloride, or neutral surfactants, such as Triton X100.

Examples of a boron compound according to the invention are all boron compounds which are soluble in the solvent according to the invention, boron compounds which are soluble in undecomposed or decomposed form, or boron compounds which are soluble in water, boron compounds which are soluble in undecomposed or decomposed form, such as hydrolyzing boron compounds. It is possible to use those which are used according to the invention for the preparation of boron-containing silica. It is possible to use water-soluble boron compounds, such as water-soluble boron oxides, such as B₂O₃, water-soluble boric acid, such as B(OH)₃ or HB(OH)₄, HBO₂, salts of boric acid, such as sodium salts, such as sodium metaborate, such as NaBO₃ or borax, Na₂B₄O₇.10H₂O.

Further examples of aqueous dispersions according to the invention are preferably those which contains 0.1-70% by weight of a boron-containing SILICA with BET=25-100 m²/g, optionally other silicas and optionally other finely divided and colloidal solids, and contain water and optionally other additives, such as, for example, mineral acids, such as phosphoric acid, or organic acids, such as malic acid or propionic acid, or inorganic bases, such as potassium hydroxide or sodium hydroxide or ammonia, or organic bases, such as triethanolamine, or polymers, such as polyethylene glycol or polypropylene glycol, or surfactants, such as anionic surfactants, such as dodecanesulfonic acid, or cationic surfactants, such as cetylpyridinium chloride, or neutral surfactants, such as Triton X100.

Further examples of aqueous dispersions according to the invention are preferably those which contain 0.1-50% by weight of a boron-containing SILICA with BET=100-200 m²/g, optionally other silicas and optionally other finely divided and colloidal solids, and contain water and optionally other additives, such as, for example, mineral acids, such as phosphoric acid, or organic acids, such as malic acid or propionic acid, or inorganic bases, such as potassium hydroxide or sodium hydroxide or ammonia, or organic bases, such as triethanolamine, or polymers, such as polyethylene glycol or polypropylene glycol, or surfactants, such as anionic surfactants, such as dodecanesulfonic acid, or cationic surfactants, such as cetylpyridinium chloride, or neutral surfactants, such as Triton X100.

Further examples of aqueous dispersions according to the invention are preferably those which contains 0.1-40% by weight of a boron-containing SILICA with BET=200-450 m²/g, optionally other silicas and optionally other finely divided and colloidal solids, and contain water and optionally other additives, such as, for example, mineral acids, such as phosphoric acid, or organic acids, such as malic acid or propionic acid, or inorganic bases, such as potassium hydroxide or sodium hydroxide or ammonia, or organic bases, such as triethanolamine, or polymers, such as polyethylene glycol or polypropylene glycol, or surfactants, such as anionic surfactants, such as dodecanesulfonic acid, or cationic surfactants, such as cetylpyridinium chloride, or neutral surfactants, such as Triton X100.

In addition to aqueous dispersions, preferably dispersions in other polar protic liquid media, such as alcohols, such as methanol, ethanol or isopropanol, di- and polyols, such as ethylene glycol, propylene glycol or glycerol, polar aprotic liquid media, such as ethers, such as tetrahydrofuran, ketones, such as acetone or isobutyl ketone, esters, such as ethyl acetate, amides, such as dimethylformamide, or sulfoxides, such as dimethyl sulfoxide, and nonpolar liquid media, such as alkanes, such as cyclohexane, or aromatics, such as toluene, are also possible.

Preferably, for reasons of handling and toxicology, water is suitable as a liquid medium.

The boron-containing silica can in principle be prepared by various methods.

Method 1

In the known processes for the preparation of pyrogenic silica, which are based on a flame process at temperatures of, for example, above 1000° C., and comprises the reaction of a vaporizable silane, such as, for example, silicon tetrachloride, hydrogensilicon trichloride, methylsilicon trichloride, or hydrogenmethylsilicon dichloride, in a flame, for example from the combustion of hydrogen gas and oxygen gas, with which substoichiometric amounts of lower alkanes, such as methane, may also be mixed, one or more vaporizable boron compounds, e.g. boron trichloride or trimethyl borate, are also added.

The ratio of boron in the vaporizable boron compound to Si in the vaporizable silane corresponds in the mixture preferably in an amount of from 0.0001% by weight to 50% by weight of boron, preferably 0.1-50% by weight of boron, particularly preferably 0.5-25% by weight of boron, very particularly preferably 0.5-5% by weight of boron.

The ratio of boron in the boron-containing silica preferably corresponds to an amount of from 0.0001% by weight to 12% by weight of boron, preferably from 0.001 to 10% by weight, particularly preferably 0.1-5% by weight, very particularly preferably 0.5-2.5% by weight of boron, boron always being calculated as pure boron in the boron-containing silica, based on the total boron-containing silica.

The addition of the boron compound is advantageously effected in the evaporator, which is connected upstream of the burner; homogeneous mixing of the components in vapor form and gases fed to the burner is preferred.

Method 2

In another embodiment according to the invention, the vaporizable or liquid boron compound or boron compound dissolved in a liquid, preferably water, is sprayed, atomized or introduced as an aerosol, preferably produced via an atomizer, into the flame of the preparation of the pyrogenic silica.

The ratio of boron in the boron-containing silica preferably corresponds to an amount of from 0.0001% by weight to 12% by weight of boron, preferably from 0.001 to 10% by weight, particularly preferably 0.1-5% by weight, very particularly preferably 0.5-2.5% by weight of boron, boron always being calculated as pure boron in the boron-containing silica, based on the total boron-containing silica.

Method 3

In another embodiment according to the invention, a silica prepared by known methods, for example a silica sol, a silica gel, a diatomaceous earth, in uncalcined or calcined form, a silica prepared by a wet chemical method, i.e. a so-called precipitated silica, or a silica prepared in a flame process, a so-called pyrogenic silica, is aftertreated with one or more boron compounds. Optionally, other additional agents for surface treatment may also be added, such as water repellents, silylating agents, such as alkylchlorosilane, such as dimethyldichlorosilane, or alkylalkoxysilanes, such as dimethyldimethoxysilane, such as alkylsilazanes, such as hexamethyldisilazane, or alkylpolysiloxanes, such as polydimethylsiloxanes having an average chain length of less than 100 chain members, i.e. dimethylsilyloxy monomer units, and having reactive terminal groups, such as SiOH groups, i.e. for example dimethylsilanol terminal groups, or nonreactive terminal groups, such as trimethylsilyloxy groups. Examples of boron compounds are covalent boron compounds, such as boron halides, e.g. boron trichloride, or boron alcoholates, such as trimethyl borate or triethyl borate, or water-soluble salts of boron, such as sodium borates, such as Na₃BO₃ or NaBO₂ or borax. Furthermore, boron compounds soluble in organic solvents are also suitable.

In a particular embodiment, a hydrophilic pyrogenic silica which is prepared under anhydrous conditions is used as a base (starting) material of the surface treatment with a boron compound. Here, anhydrous is to be understood as meaning that no additional water, either in liquid or in vapor form, is fed into the process, either in the hydrothermal preparation process or in the further steps of the process, such as cooling, purification and storage, up to the ready-prepared and purified, packed product ready for shipping. In any case, not more than 5% by weight of water, based on the total weight of the silica, are added; preferably, as little water as possible is added, particularly preferably no water at all.

A further subject is a method for coating silica, in hydrophilic or hydrophobic or silylated form, characterized in that the silica is surface-treated with one or more volatile, liquid or soluble boron compounds.

For example, the boron compound has the formula
R¹ₐBX_{b} (I)
or
R¹_{c}B(OR²)_{d} (II)

in which a+b=3 and c+d=3

preferably b=3

preferably d=3

and

X=a halogen, preferably chlorine.

R¹ is an optionally mono- or polyunsaturated, monovalent, optionally halogenated hydrocarbon radical having 1 to 18 carbon atoms and may be identical or different.

R¹ is preferably a methyl or ethyl group, particularly preferably, for reasons of availability, a methyl group.

R² is an optionally mono- or polyunsaturated, monovalent, optionally halogenated hydrocarbon radical having 1 to 12 carbon atoms and may be identical or different.

Examples of R¹ are alkyl radicals, such as the methyl radical, the ethyl radical, propyl radicals, such as the isopropyl or the n-propyl radical, butyl radicals, such as the tert-butyl or n-butyl radical, pentyl radicals, such as the neopentyl, the isopentyl or the n-pentyl radicals, hexyl radicals, such as the n-hexyl radical, heptyl radicals, such as the n-heptyl radical, octyl radicals, such as the 2-ethylhexyl or the n-octyl radical, decyl radicals, such as the n-decyl radical, dodecyl radicals, such as the n-dodecyl radical, hexadecyl radicals, such as the n-hexadecyl radical, octadecyl radicals, such as the n-octadecyl radical, alkenyl radicals, such as the vinyl, the 2-allyl or the 5-hexenyl radical, aryl radicals, such as the phenyl, the biphenyl or naphthenyl radical, alkylaryl radicals, such as benzyl, ethylphenyl, toluyl or the xylyl radicals, halogenated alkyl radicals, such as the 3-chloropropyl radical.

The methyl radical and the ethyl radical are preferred example of R¹, the methyl radical being particularly preferred.

Examples of R² are alkyl radicals, such as the methyl radical, the ethyl radical, propyl radicals, such as the isopropyl or the n-propyl radical, butyl radicals, such as the tert-butyl or n-butyl radical, pentyl radicals, such as the neopentyl, the isopentyl or the n-pentyl radicals, hexyl radicals, such as the n-hexyl radical, heptyl radicals, such as the n-heptyl radical, octyl radicals, such as 2-ethylhexyl or the n-octyl radical, decyl radicals, such as the n-decyl radical, and dodecyl radicals, such as the n-dodecyl radical.

Preferred examples of R² are the methyl radical and the ethyl radical, the methyl radical being particularly preferred.

Particularly preferred examples of boron compounds are boron trichloride and trialkyl borate, trimethyl borate being preferred.

The ratio of boron in the boron-containing silica preferably corresponds to an amount of from 0.0001% by weight to 12% by weight of boron, preferably from 0.001 to 10% by weight, particularly preferably 0.1-5% by weight, particularly preferably 0.5-5% by weight of boron, boron always being calculated as pure boron in the boron-containing silica, based on the total boron-containing silica.

Starting Silica for Method 3

The starting silica preferably has a mean primary particle size of less than 100 nm, preferably with a mean primary particle size of from 5 to 50 nm. These primary particles do not exist in isolation in the silica but are components of larger aggregates and agglomerates.

The silica preferably has a specific surface area of from 25 to 500 m²/g (measured by the BET method according to DIN 66131 and 66132).

The silica comprises aggregates (definition according to DIN 53206) in the range of diameters from 100 to 1000 nm, the silica comprising agglomerates (definition according to DIN 53206) which are composed of aggregates and, depending on the external shear load (e.g. measuring conditions), have sizes of from 1 to 500 μm.

Preferably, the silica has a fractal dimension of the surface of, preferably, less than or equal to 2.3, preferably of less than or equal to 2.1, particularly preferably of from 1.95 to 2.05, the fractal dimension of the surface Dₛ being defined here as:

Particle surface area A is proportional to the particle radius R to the power Dₛ.

Preferably, the silica has a fractal dimension of the mass Dₘ of, preferably, less than or equal to 2.8, preferably equal to or less than 2.7, particularly preferably from 2.4 to 2.6. The fractal dimension of the mass Dₘ is defined here as:

Particle mass M is proportional to the particle radius R to the power Dₘ.

Preferably, the silica has a density of surface silanol groups SiOH of less than 2.5 SiOH/nm², preferably less than 2.1 SiOH nm², preferably of less than 1.9 SiOH/nm², particularly preferably form 1.7 to 1.9 SiOH/nm².

Silicas prepared at high temperature (above 1000° C.) may be used. Silicas prepared by a pyrogenic method are particularly preferred. It is also possible to use hydrophilic silica which are freshly prepared and obtained directly from the burner, temporarily stored or already commercially packed. Water-repellent or silylated silicas, for example commercial ones, may also be used.

Uncompacted silicas having bulk densities of less than 60 g/l, but also compacted silicas having bulk densities greater than 60 g/l, may be used.

Mixtures of different silicas may be used, for example mixtures of silicas of different BET surface area, or mixtures of silicas with a different degree of water repellency or degree of silylation.
The surface modification with boron can be carried out as a discontinuous reaction, i.e. by the batch method, or as a continuous reaction. For technical reasons, a continuous reaction is preferred.
The reaction can be realized in one step or in 2 or 3 successive steps. In other words, a loading (physisorption of the boron compound) and a purification step may be present downstream of the reaction. 3 successive steps are preferred: (1) loading—(2) reaction—(3) purification.
The loading temperature is preferably from −30° C. to 350° C., preferably from 20° C. to 150° C., particularly preferably 60° C.-120° C.
The reaction temperatures preferably range from 50 to 400° C., preferably from 50° C. to 150° C.
The reaction times are preferably from 1 min to 24 h, preferably from 10 min to 8 h, particularly preferably from 30 min to 4 h.
The reaction pressure in the region of atmospheric pressure, superatmospheric pressure up to 10 bar, reduced pressure down to 0.2 bar is possible.
The purification temperature preferably ranges from 100 to 400° C., preferably from 150° C. to 300° C.
Effective movement and thorough mixing of SILICA and boron compound are not necessary. This is preferably effected by mechanical and gas-supported fluidization. Gas-supported fluidization may be effected by means of all inert gases which do not react with the boron compound, the SILICA, the boron-containing SILICA and products of secondary reactions, i.e. do not lead to secondary reactions, degradation reactions, oxidation processes and flame and explosion phenomena: such as N₂, Ar, other noble gases, CO₂, etc. The gases for the fluidization are preferably fed in in the range of empty tube gas velocities of from 0.05 to 5 cm/s, particularly preferably of 0.05-1 cm/s. Mechanical fluidization can be effected by means of paddle stirrers, anchor stirrers and other suitable stirring elements.
In a particularly preferred embodiment, only that amount of gas which is sufficient for maintaining a low-oxygen atmosphere, preferably less than 10% by volume, particularly preferably less than 2.5% by volume, of oxygen, is fed in, and the fluidization is then effected purely mechanically.
The reaction is preferably carried out in an atmosphere which does not lead to oxidation of the boron-loaded SILICA, i.e. a low-oxygen atmosphere, preferably less than 10% by volume of oxygen; less than 2.5% by volume are particularly preferred, the best results being obtained in the case of less than 1% by volume of oxygen.
The boron compound is introduced effectively into the SILICA. This can be carried out by using a boron compound which is in vapor form at the loading or reaction temperature. If the boron compound is a liquid compounds at room temperature and/or at reaction temperature, or a solid compound which has to be dissolved in solvent, effective spraying techniques are used, such as spraying in airless nozzles under pressure (from 5 to 20 bar), spraying in binary nozzles under pressure (gas and liquid 2-20 bar) or very fine distribution by means of atomizers.
Preferably, the boron compound is added as a very finely divided aerosol, characterized in that the aerosol has a rate of fall of preferably 0.1-20 cm/s.
Alternatively, it is possible to add preferably protic solvents, such as liquid or vaporizable alcohols or water; typical alcohols are isopropanol, ethanol and methanol. Mixtures of the abovementioned protic solvents may also be added. Water is preferably added. Water is preferably added in an amount of from 0.1 to 50% by weight, based on the silica; particularly preferred is a total amount of water or moisture, to be determined by weighing the weight difference before and after heating at a temperature of 105° C. and atmospheric pressure for 2 hours, of from 0.25% by weight to 2.5% by weight, based on a silica having a BET specific surface area of 100 m²/g, i.e. from 0.25 to 2.5% by weight, based on the silica having a BET specific surface area of 100 m²/g, correspondingly less, from 0.125 to 1.25% by weight, based on a silica having a specific surface area of 50 m²/g, and correspondingly more, from 0.75 to 7.5% by weight, based on a silica having a BET specific surface area of 300 m²/g.
Alternatively, acidic or basic catalysts may preferably be added. These may have a basic character, in the sense of a Lewis base or of a Brönsted base, such as ammonia, or may have an acidic character, in the sense of a Lewis acid or of a Brönsted acid, such as hydrogen chloride. These are preferably added in traces, i.e. less than 1000 ppm. Particularly preferably, no catalysts are added.
The purification step is characterized by movement, slow movement and slight mixing being preferred.
The purification step is furthermore characterized by increased gas introduction, corresponding to an empty tube gas velocity of from 0.001 to 10 cm/s, preferably from 0.01 to 1 cm/s.
In addition, the purification step may comprise mixing by means of mechanical stirring elements. The stirring elements are adjusted and moved in such a way that preferably mixing and fluidization but not complete vortexing occurs.
In addition, methods for mechanical compaction, such as, for example, press rolls, ball mills, edge mills, screw compactors or briquetting machines, may be used during the addition of the boron compound.
In addition, methods for deagglomeration of the silica, such as pinned-disk mills or apparatuses for combined milling and classification, may be used during the addition of the boron compound.
In addition, methods for mechanical compaction of the silica, such as, for example, press rolls, or compaction by extraction of the air or gas content by suitable vacuum methods or other methods for mechanical compaction, such as, for example, press rolls, ball mills, edge mills, screw compactors or briquetting machines, may be used after the purification method.
In addition, methods for deagglomeration of the silica, such as pinned-disk mills or apparatuses for combined milling and classification, may be used after the purification.
In a preferred embodiment, the unreacted boron compound, products of secondary reactions, excess amounts of the added boron compound which have not been chemically fixed and have been optionally modified, waste products and waste gases from the purification step is recycled in suitably thermostated apparatuses back to the step comprising coating and loading of the silica; this can be effected partly or completely, preferably to an extent of 50-90% of the total volume flow of the gas volumes emerging from the purification.

The ratio of boron in the boron-containing silica preferably corresponds to an amount of from 0.0001% by weight to 12% by weight of boron, preferably from 0.001 to 10% by weight, particularly preferably 0.1-5% by weight, very particularly preferably 0.5-2.5% by weight of boron, boron always being calculated as pure boron in the boron-containing silica, based on the total boron-containing silica.

A further subject is a silica which contains boron, on the surface or incorporated into the entire volume of the silica, and which has a mean primary particle size of less than 100 nm, preferably a mean primary particle size of from 5 to 50 nm, these primary particles not existing in isolated form in the silica but being components of larger aggregates (definition according to DIN 53206) which have a diameter of from 100 to 1000 nm and form agglomerates (definition according to DIN 53206) which, depending on the external shear load, have sizes of from 1 to 500 μm, has a specific surface area of from 10 to 500 m²/g (measured by the BET method according to DIN 66131 and 66132) and a fractal dimension of the mass Dₘ of less than or equal to 2.8 and has a boron content of, preferably, from 0.0001% by weight to 12% by weight of boron, preferably from 0.001 to 10% by weight, particularly from 0.1 to 5% by weight, very particularly preferably 0.5-2.5% by weight of boron, boron always being calculated as pure boron in the boron-containing silica, based on the total boron-containing silica.

The boron-containing SILICA according to the invention is furthermore characterized in that it can be used for the preparation of aqueous dispersions having a high solids content, with high storage stability of the viscosity, freedom from sedimentation and without gelling.

The invention relates to the use of the boron-containing SILICA according to the invention in pulverulent solids for improving the flowability of the dry powder, i.e. for improving the free-flowing properties, i.e. the use as a flow improver; furthermore for suppressing agglomeration and caking of powders, for suppression of adhesion and blocking of films.

The invention furthermore relates to a recording medium, for example a paper or a film, which is suitable for printing using inkjet printers, in particular a paper having high gloss, characterized in that it has a dispersion according to the invention.

The invention relates to the use of the boron-containing SILICA according to the invention and the boron-containing silica-containing aqueous dispersions prepared therewith in the coating of surfaces, such as mineral substrates, such as metals, e.g. steel or iron, for example with the aim of corrosion protection.

The invention relates to the use of the boron-containing SILICA according to the invention and the boron-containing silica-containing aqueous dispersions prepared therewith in the preparation of paints and finishes, synthetic resins, adhesives and sealants, in particular those which are prepared with a water base.

The invention relates to the use of the boron-containing SILICA according to the invention and the boron-containing silica-containing aqueous dispersions prepared therewith in the coating of recording media, in particular those papers which are used in noncontact printing methods. Examples are papers for inkjet printers and in particular those papers having high gloss.

### EXAMPLES

### Example 1

10.0 kg/h of silicon tetrachloride and 0.8 kg/h of boron trichloride are homogeneously mixed with 74.3 m³(S.T.P.)/h of primary air and 20.7 m³ (S.T.P.)/h of hydrogen gas in a mixing chamber and passed, in a burner nozzle of known design in a flame, into a combustion chamber. 12.0 m³ (S.T.P.)/h of secondary air are additionally blown into the combustion chamber. After emergence from the combustion chamber, the resulting silica/gas mixture is cooled to 120-150° C. in a heat exchanger system, and the solid silica is then separated from the hydrogen chloride-containing gas phase in a heated filter system. At elevated temperature, residues of hydrogen chloride are then removed. A boron-containing pyrogenic silica having a specific surface area, measured by the BET method according to DIN 66131 and 66132, of 180 m²/g is obtained, the 4% strength (% by weight) dispersion having a pH (DIN/ISO 787/9) of 4. The boron content of the silica is 1.8% by weight.

### Example 2

5.0 kg/h of silicon tetrachloride are homogeneously mixed with 74.3 m³ (S.T.P.)/h of primary air and 20.7 m³ (S.T.P.)/h of hydrogen gas in a mixing chamber and passed, in a burner nozzle of known design in a flame, into a combustion chamber. 12.0 m³(S.T.P.)/h of secondary air are additionally blown into the combustion chamber. 0.2 kg/h of sodium borate dissolved in 1 kg/h of water is additionally sprayed as an aerosol into the combustion chamber. After emergence from the combustion chamber, the resulting silica gas mixture is cooled to 120-150° C. in a heat exchanger system, and the solid silica is then separated from the hydrogen chloride-containing gas phase in a heated filter system. At elevated temperature, residues of hydrogen chloride are then removed. A boron-containing pyrogenic silica having a specific surface area, measured by the BET method according to DIN 66131 and 66132, of 110 m²/g is obtained, the 4% strength (% by weight) dispersion having a pH (DIN/ISO 787/9) of 6. The boron content of the silica is 0.8% by weight.

### Example 3

In a continuous apparatus, at a temperature of 25° C. under N₂ inert gas, 200 g/h of trimethyl borate in liquid, very finely divided form are added, by atomization via a one-material nozzle (pressure 10 bar) to a mass flow of 1000 g/h of hydrophilic SILICA, having a specific surface area of 300 m²/g (measured by the BET method according to DIN 66131 and 66132) (obtainable under the name WACKER HDK T30 from Wacker-Chemie GmbH, Burghausen, Germany), which was moistened to a water content of 2.5% by weight of water. The SILICA laden in this manner is thermostated at 100° C. for a residence time of 1 h, and it is then reacted during a residence time of 2 hours at a temperature of 250° C. Purification is then effected with mechanical stirring and passage of N₂ at a gas velocity of less than 0.5 cm/s at a temperature of 150° C. and in the course of 30 min. A white SILICA powder comprising 1.8% by weight of boron is obtained.

### Example 4

In a batchwise apparatus, at a temperature of 25° C. under N₂ inert gas, 50 g of trimethyl borate in liquid, very finely divided form is added, by atomization via a one-material nozzle (pressure 20 bar), to 100 g of hydrophilic SILICA having a specific surface area of 50 m²/g (measured by the BET method according to DIN 66131 and 66132) (obtainable under the name WACKER HDK D05 from Wacker-Chemie GmbH, Burghausen, Germany), which was moistened to a water content of 0.6% by weight. The SILICA laden in this manner is thermostated at 100° C. for a total of 3 h and is then reacted for a residence time of 2 hours at a temperature of 250° C. in a reactor, with introduction of N₂ with 15-fold gas exchange during the reaction time. A white SILICA powder having a boron content of 4.1% by weight is obtained.

### Example 5

In a batchwise apparatus, at a temperature of 25° C., 300 g boron-containing SILICA from example 3 are added in small steps to 700 ml of water and dispersed using a rotor-stator dispersing unit, an Ultraturax from Jahnke and Kunkel. A low-viscosity whitish aqueous suspension having a boron content of 0.5% by weight forms. The suspension is stable to sedimentation and gelling for more than six months. The suspension has a viscosity at a shear gradient of 100 l/s, measured at 25° C. and using a cone-and-plate rotational viscometer from Haake, RheoStress 600 a viscosity of 120 mPa·s.

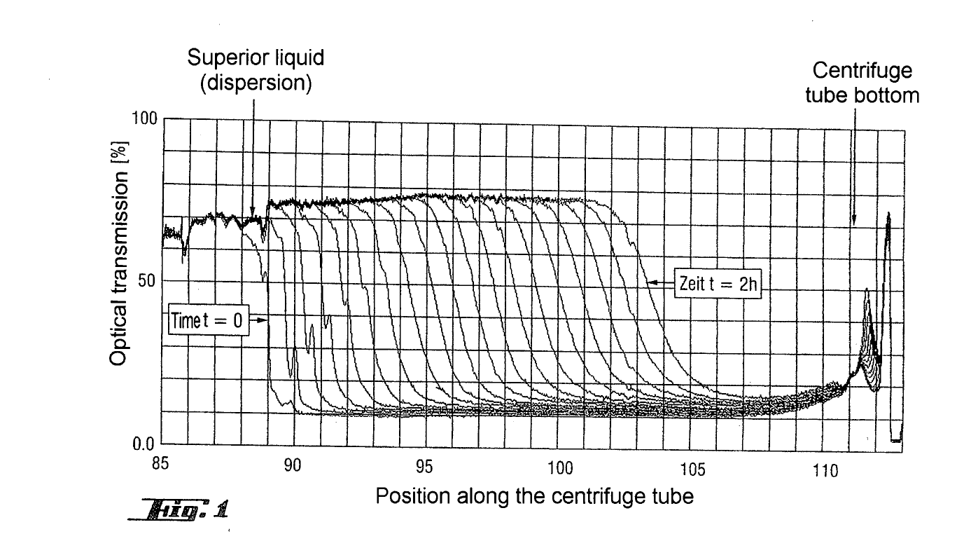

The stability to sedimentation is documented by measurement using the centrifuge controlled by optical transmittance, Luminofuge® apparatus. cf. FIG. 1 (reference not according to the invention):

Laser light transmission profile recorded using the Lumifuge® (here, sedimentation is produced by centrifuging with a rotation corresponding to 3000 g; by means of an array of 2000 diodes, the sedimentation of the silica is monitored via laser light transmittance during the centrifuging).

Abscissa (X axis): longitudinal axis of the centrifuge tube in mm (left: orifice, right: bottom); ordinate (Y axis): light transmittance in percent (%).

Transmission profile, recorded using the Lumifuge®, of a dispersion not according to the invention; monodisperse silica spheres 220 nm, duration of measurement 120 min, gravitational field 3000 g: strong sedimentation of an unstable dispersion is observed.

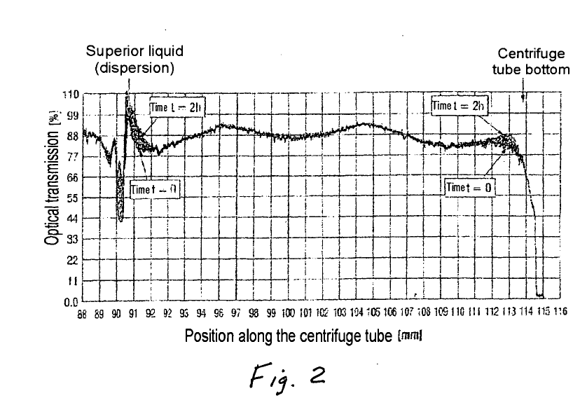

and FIG. 2 example 5 according to the invention):

Laser light transmission profile recorded using the Lumifuge® (here, sedimentation is produced by centrifuging with a rotation corresponding to 3000 g; by means of an array of 2000 diodes, the sedimentation of the silica is monitored via laser light. transmittance during the centrifuging).

Abscissa (x axis): longitudinal axis of the centrifuge tube (left: orifice, right: bottom); ordinate (Y axis): light transmittance in percent (%).

Transmission profile, recorded using the Lumifuge®, of a dispersion according to the invention and according to example 5; duration of measurement 120 min, gravitational field 3000 g: no sedimentation is observable.

### Example 6

In a batchwise apparatus, at a temperature of 25° C., 250 g boron-containing SILICA from example 3 are added in small steps to 750 ml of water and dispersed using a toothed-disk dissolver from Ika, at a rotational speed of 11.6 m/s. A low-viscosity whitish aqueous suspension having a boron content of 0.5% by weight forms. The suspension is stable to sedimentation and gelling for more than one year. The suspension has a viscosity at a shear gradient of 100 l/s, measured at 25° C. and using a cone-and-plate rotational viscometer from Haake, RheoStress 600 a viscosity of 130 mPa·s.

### Example 7

In a batchwise apparatus, at a temperature of 25° C., 2000 g boron-containing SILICA from example 4 are added in small steps to 2000 ml of water and dispersed using a rotor-stator dispersing unit, a 6 l Unimix from Unimix/Ekator. A low-viscosity whitish aqueous suspension having a boron content of 2% by weight forms. The suspension is stable to sedimentation and gelling for more than one year. The suspension has a viscosity at a shear gradient of 100 l/s, measured at 25° C. and using a cone-and-plate rotational viscometer from Haake, RheoStress 600 a viscosity of 190 mPa·s.

### Example 8

8 g of polyvinyl alcohol, dissolved in 50 g of water, are added to 100 g of the dispersion from example 5, containing 30 g of silica from example 3, and are mixed. The inkjet coating ink thus produced is applied manually by means of a knife coater to an uncoated paper of 77.5 g/m² basis weight, and the coated paper is dried in air until it is dry to the touch. The dried paper is calendered and is printed on using an Epson® Stylus pro Photorealistic. The image quality is excellent. The gloss of the print was determined as 47 using a Gardener 60° Micro-Gloss Meter.

### Example 9

8 g of polyvinyl alcohol (Mowiol 26-88, from Clariant), dissolved in 50 g of water, are added to 100 g of the dispersion from example 5, containing 30 g of silica from example 3, and are mixed. The inkjet coating ink thus produced is applied manually using a knife coater to a 0.2 mm thick polyester film, with a wet film thickness of 160 μm, and the coated film is dried at 105° C. for 15 min. The coated film is printed on using an Epson® Stylus Colour 800. The image quality is excellent.

### Example 10

In a batchwise apparatus, at a temperature of 25° C., 250 g of SILICA having a BET surface area of 300 m²/g (obtainable from Wacker-Chemie GmbH under the name Wacker HDK T30) are added in small steps to 750 ml of water and 25 g of boric acid and dispersed using a rotor-stator dispersing unit, an Ultraturax from Jahnke and Kunkel, at 11 000 rpm. A low-viscosity whitish aqueous suspension having a boron content of 0.8% by weight forms. The suspension is stable to sedimentation and gelling for more than six months. The suspension has a viscosity at a shear gradient of 100 l/s, measured at 25° C. and using a cone-and-plate rotational viscometer from Haake, RheoStress 600 a viscosity of 120 mPa·s.

### Example 11

8 g of polyvinyl alcohol, dissolved in 50 g of water, are added to 100 g of the dispersion from example 10 and are mixed. The inkjet coating ink thus produced is applied manually using a knife coater to an uncoated paper of 77.5 g/m² basis weight, and the coated paper is dried in air until it is dry to the touch. The dried paper is calendered and is printed on using an Epson® Stylus Pro Photorealistic. The image quality is excellent. The gloss of the print was determined as 47 using a Gardener 60° Micro-Gloss Meter.

### Example 12

8 g of polyvinyl alcohol (Mowiol 26-88, from Clariant), dissolved in 50 g of water, are added to 100 g of the dispersion from example 10 and are mixed. The inkjet coating ink thus produced is applied manually using a knife coater to a 0.2 mm thick polyester film, with a wet film thickness of 160 μm, and the coated film is dried at 105° C. for 15 min. The coated film is printed on using an Epson® Stylus Colour 800. The image quality is excellent.

1-17. (canceled)

18. A method for stabilizing a dispersion of metal oxide(s), comprising including boron in the dispersion.

19. The method of claim 18, wherein at least one metal oxide is silica.

20. The method of claim 19, wherein boron is contained in the dispersion in an amount of from 0.00001% by weight to 8% by weight.

21. The method of claim 19, wherein the silica contains boron.

22. The method of claim 21, wherein boron is contained in the silica in an amount of from 0.0001% by weight to 12% by weight.

23. A dispersion of at least one metal oxide, containing a stabilizing effective amount of boron.

24. The dispersion of claim 23, comprising boron-containing silica.

25. The dispersion of claim 23, wherein boron is present in an amount of from 0.00001% by weight to 8% by weight, based on the total weight of the dispersion.

26. The dispersion of claim 24, wherein silica contains boron in an amount of from 0.0001% by weight to 12% by weight, based on the total boron-containing silica.

27. A silica, having at least with one boron compound as a coating thereon.

28. The silica of claim 27, wherein the silica has a mean primary particle size of less than 100 nm, these primary particles not existing in isolated form in the silica but being components of larger aggregates according to DIN 53206 which have a diameter of from 100 to 1000 nm and form agglomerates according to DIN 53206 which, depending on the external shear load, have sizes of from 1 to 500 μm, and have a specific surface area of from 10 to 500 m²/g measured by the BET method according to DIN 66131 and 66132, a fractal dimension of the mass Dₘ of less than or equal to 2.8 and a boron content of at least 0.0001% by weight.

29. A method for modifying silica, comprising surface-treating silica with one or more volatile, liquid or soluble, boron compounds.

30. A method for modifying silica, comprising spraying into a flame during the preparation of the pyrogenic silica in a flame, one or more liquid boron compounds or boron compounds dissolved in a solvent.

31. A recording medium, comprising a dispersion of claim 23.

32. The recording medium of claim 31, comprising a glazed or high-gloss paper which is suitable for printing on by means of inkjet printers.

33. The recording medium of claim 31, comprising a film which is suitable for printing by means of inkjet printers.

34. A surface coating, comprising a dispersion of claim 23.
